(19) United States
(12) Patent Application Publication
(10) Pub. No.: US 2014/0095216 A1
(43) Pub. Date: Apr. 3, 2014

(54) ITINERARY-BASED EVENT RECOMMENDATIONS

(71) Applicant: INTERNATIONAL BUSINESS MACHINES CORPORATION, Armonk, NY (US)

(72) Inventor: Rajesh Radhakrishnan, Reston, VA (US)

(73) Assignee: INTERNATIONAL BUSINESS MACHINES CORPORATION, Armonk, NY (US)

(21) Appl. No.: 13/630,740

(22) Filed: Sep. 28, 2012

(51) Int. Cl. G01C 21/00; G06Q 10/02

(52) U.S. Cl. 705/5; 701/400

(57) ABSTRACT

Embodiments of the present invention provide a computer system, method, and computer program product for providing event recommendations to a user. User data is aggregated and analyzed to identify one or more user preferences for events. After a travel itinerary is created for the user, the user is notified of one or more events that comport with the user preferences and coincide with the travel itinerary.

### TECHNICAL FIELD

The present invention relates generally to computer systems and, more particularly, to recommending events to a user based on a travel itinerary.

### BACKGROUND

The Internet is increasingly being utilized to provide travel-related services to users around the world. For example, a user can utilize Internet-based travel services to research and plan a trip, create an itinerary, and book transportation and lodging.

Travelers that utilize such services may not always be aware of events and activities that are occurring in the places they plan on visiting. For example, an individual travelling to New York City may not be aware that his or her favorite artist is performing at a nearby venue. A difficulty in identifying events and activities that are occurring can result, for example, from a lack of reliable and consistent sources of information and the sheer number of possible events that an individual may have to sort through to identify events that he or she is interested in.

### SUMMARY

Embodiments of the present invention provide a computer system, method, and computer program product for providing event recommendations to a user. According to one aspect of the present invention, a computer system identifies a travel itinerary that has been created for a user, wherein the travel itinerary includes at least one scheduled time and location. The computer system aggregates data that pertains to the user from one or more service providers. The computer system analyzes the aggregated data to identify a user preference. The computer system identifies an event of potential interest to the user that coincides with the travel itinerary. The computer system then notifies the user of the identified event.

### BRIEF DESCRIPTION OF THE SEVERAL VIEWS OF THE DRAWINGS

FIG. 1 is a functional block diagram of a data system in accordance with an embodiment of the present invention.

FIG. 2 is a flowchart illustrating operational steps for setting up a user profile in accordance with an embodiment of the present invention.

FIG. 3 is a flowchart illustrating operational steps for aggregating user information and event information in accordance with an embodiment of the present invention.

FIG. 4 is a flowchart illustrating operational steps for recommending events to a user in accordance with an embodiment of the present invention.

FIG. 5 is a block diagram of internal and external components of the computer systems of FIG. 1 in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable mediums having computer-readable program code embodied thereon.

Any combination of one or more computer-readable media may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device. A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Briefly, embodiments of the present invention recommend events to a user based on user preferences and a travel itinerary. The term “event,” as used in this specification, refers generally to social and cultural events and activities. Examples of events include, but are not limited to, concerts, plays, movies, sporting events, festivals and other scheduled gatherings, and attractions. Embodiments of the present invention aggregate and analyze users' data to identify users' preferences for such events. The term “preference,” as used in this specification, refers generally to an explicit or implicit affinity or dislike for specific events and/or certain types of events. For example, a preference can pertain to a specific event such as a particular concert, and/or types of events such as events involving certain individuals (e.g., a performer, sports team, etc.), certain genres of music (e.g., classical music), certain types of sports (e.g., football), or any other aspects.

Accordingly, when a travel itinerary is created for a user, embodiments of the present invention can recommend events that comport with the user's preferences and coincide with the user's itinerary, which can help apprise the user of events that he or she might not otherwise have known about and allow the user to incorporate the identified events into his or her travel plans.

Embodiments of the present invention will now be described in detail with reference to the accompanying Figures.

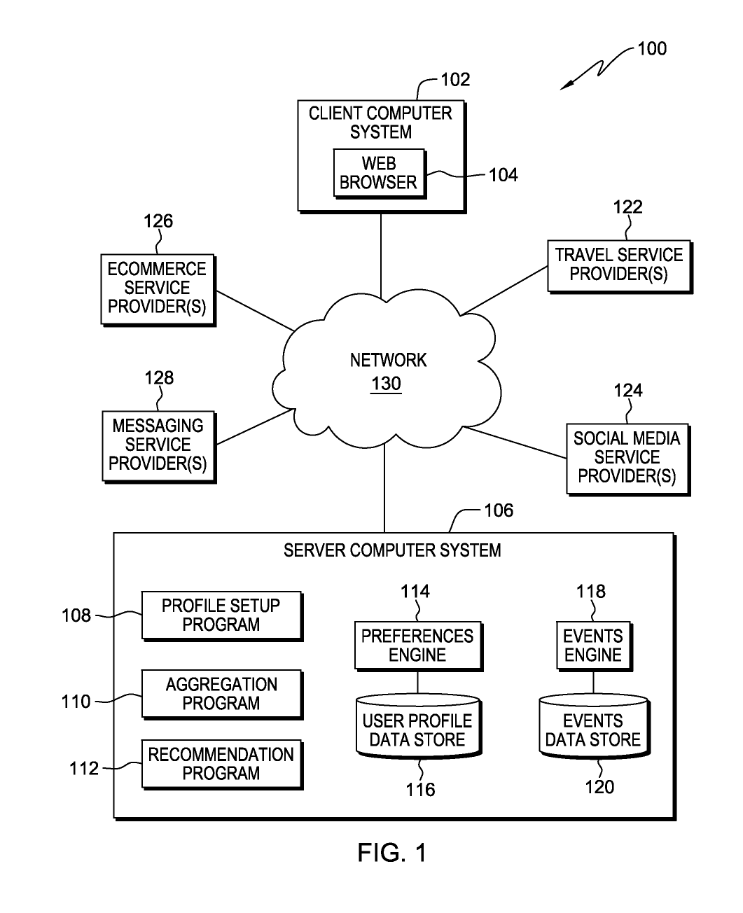

FIG. 1 is a functional block diagram of a data system 100 in accordance with an embodiment of the present invention. Data system 100 includes client computer system 102, server computer system 106, one or more travel service providers 122, one or more social media service providers 124, one or more ecommerce service providers 126, and one or more messaging service providers 128, interconnected over network 130.

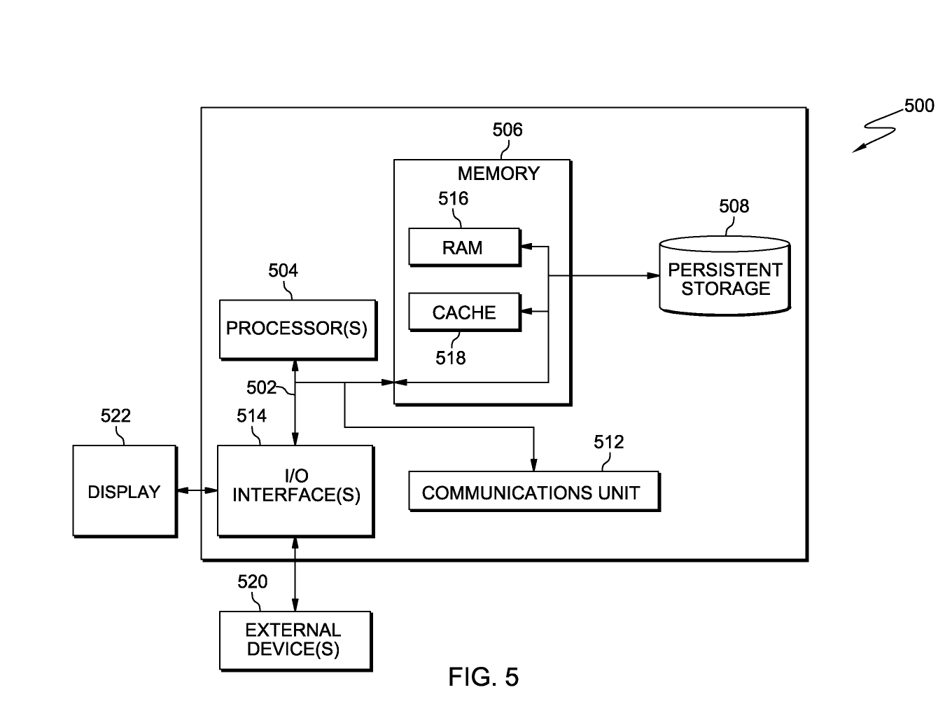

Client computer system 102 and server computer system 106 can be desktop computers, laptop computers, specialized computer servers, or any other computer systems known in the art. In certain embodiments, client computer system 102 and server computer system 106 represent computer systems utilizing clustered computers and components that each act as a single pool of seamless resources when accessed through network 130. In general, client computer system 102 and server computer system 106 are representative of any electronic devices or combination of electronic devices capable of executing machine-readable program instructions, as described in greater detail with regard to FIG. 5. In this exemplary embodiment, service providers 122 through 128 represent computer systems utilizing clustered computers and components that each act as a single pool of seamless resources to provide their respective services when accessed through network 130 (e.g., accessed via a URL).

Network 130 can be, for example, a local area network (LAN), a wide area network (WAN) such as the Internet, or a combination of the two, and include wired, wireless, or fiber optic connections. In general, network 130 can be any combination of connections and protocols that will support communications between client computer system 102, server computer system 106, and service providers 122 through 128 in accordance with a desired embodiment of the invention.

Client computer system 102 includes web browser 104. Web browser 104 enables a user of client computer system 102 to access server computer system 106 via network 130 to set up a user profile and receive event recommendations in accordance with embodiments of the present invention. Web browser 104 also enables a user of client computer system 102 to access one or more travel service providers 122 (e.g., to plan a trip and create an itinerary), one or more social media service providers 124 (e.g., to interact with friends and colleagues), one or more ecommerce service providers 126 (e.g., to make purchases), and one or more messaging service providers 128 (e.g., to send and receive electronic messages) via network 130. Web browser 104 can be implemented with existing web browser software and/or as a customized application, such as a customized mobile phone app.

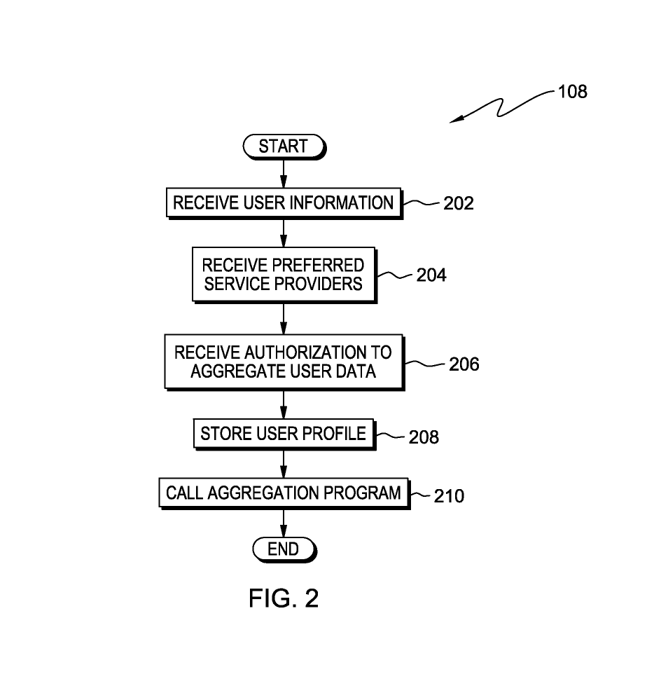

Server computer system 106 includes profile setup program 108, aggregation program 110, recommendation program 112, preferences engine 114, user profile data store 116, events engine 118, and events data store 120. Profile setup program 108 enables a user of client computer system 102 to create a user profile in accordance with embodiments of the present invention, as discussed in greater detail with regard to FIG. 2.

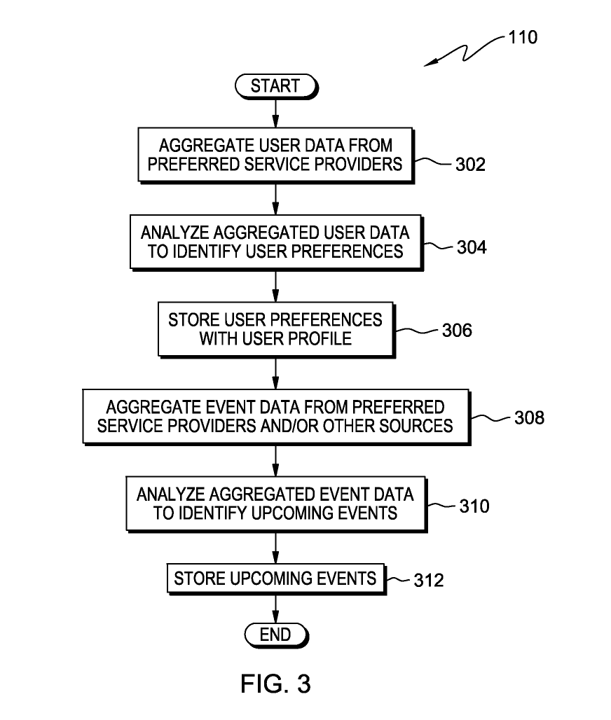

Aggregation program 110 aggregates user data from service providers 122 through 128 in accordance with embodiments of the present invention. Aggregation program 110 also aggregates data pertaining to events from service providers 122 through 128 and/or other sources. Aggregation program 110 utilizes preferences engine 114 to analyze the aggregated user data to identify one or more user preferences and store the preferences in user profile data store 116. Aggregation program 110 utilizes events engine 118 to analyze the aggregated events data to identify one or more events and store the information pertaining to the events (e.g., scheduled time and location) in events data store 120. Aggregation program 110 is discussed in greater detail with regard to FIG. 3.

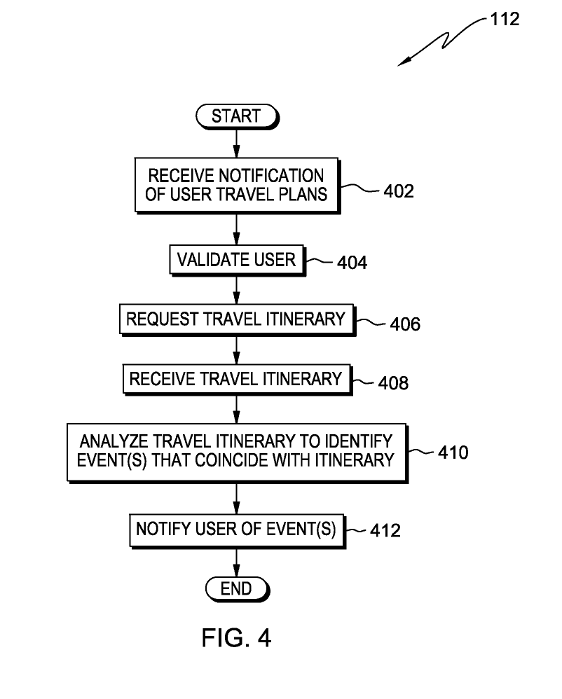

Recommendation program 112 is utilized to analyze a travel itinerary that has been created for a user using one or more travel service providers 122, identify one or more events that both coincide with the travel itinerary and comport with the user's preferences for events, and notify the user of the identified events in accordance with embodiments of the present invention. Recommendation program 112 is discussed in greater detail with regard to FIG. 4.

One or more travel service providers 122 enable a user of client computer system 102 to create an itinerary and make travel arrangements via web browser 104 and network 130. In this exemplary embodiment, one or more travel service providers 122 are separate from server computer system 106. In other embodiments, one or more travel service providers 122 can be integrated with server computer system 106.

One or more social media service providers 124 enable a user to interact with friends and/or colleagues via web browser 104 and network 130. For example, one or more social media service providers 124 may include services which allow a user to maintain a network of friends or colleagues, post information on friends' personal web pages, and send and receive other electronic messages.

One or more ecommerce service providers 126 enable a user to make purchases via web browser 104 and network 130. For example, one or more ecommerce service providers 126 may include services to purchase tickets for transportation and events.

One or more messaging service providers 128 enable a user to send and receive electronic messages via web browser 104 and network 130. For example, one or more messaging service providers 128 may include e-mail, instant messaging, and chat services.

It should be understood that, for illustrative purposes, FIG. 1 does not show other computer systems and elements which may be present when implementing embodiments of the present invention. For example, while this illustrative embodiment includes service providers 122 through 128, other embodiments of the present invention can include fewer or greater numbers of service providers, as well as different types of service providers.

FIG. 2 is a flowchart illustrating operational steps of profile setup program 108 for setting up a user profile in accordance with an embodiment of the present invention. In step 202, profile setup program 108 receives user information entered by a user using web browser 104. In this exemplary embodiment, the user enters basic personal information such as his or her name and email address. In other embodiments, the user may enter additional information, such as payment information for fees associated with using data system 100.

In step 204, profile setup program 108 receives one or more preferred service providers that have been specified by the user using web browser 104. The preferred service providers, as specified by the user, serve as a source of user data for later identifying user preferences. In this exemplary embodiment, service providers 122 through 128 are preferred service providers and are specified by entering their respective URLs.

In step 206, profile setup program 108 receives authorization to aggregate user data from the user. In this exemplary embodiment, the user, using web browser 104, provides authorization to aggregate data about the user from service providers 122 through 128. Such authorization can take many forms. In this exemplary embodiment, the user provides authorization for server computer system 106 and service providers 122 through 128 to use federated identity management technology to maintain a common user ID across each of these services and collect relevant user data. In other embodiments, the user provides authorization by providing his or her login credentials for the preferred service providers such that relevant user data can be collected. In other embodiments, the user authorizes the use of entity analytics to identify the user and collect relevant user data based on his or her ordinary usage of server computer system 106 and service providers 122 through 128.

In step 208, profile setup program 108 stores the received user information, preferred service providers, and authorization as a unique user profile in user profile data store 116. The user profile can be further configured with a login name and password such that the user can later modify settings such as the preferred service providers and authorizations.

In step 210, profile setup program 108 calls aggregation program 110, which aggregates user and event data, as discussed in greater detail with regard to FIG. 3.

FIG. 3 is a flowchart illustrating operational steps of aggregation program 110 for aggregating user data and event data in accordance with an embodiment of the present invention. In step 302, aggregation program 110 aggregates user data from the preferred service providers, as specified during profile setup (i.e., service providers 122 through 128). Depending on the nature of the service providers, the user data that is aggregated from the service providers may include, for example, data pertaining to individuals, groups, and subjects with which the user associates, historical data pertaining to events the user has attended and goods the user has purchased, and text content from messages sent and received by the user via e-mail, instant messages, or posts on a personal web page.

In step 304, aggregation program 110 utilizes preferences engine 114 to analyze the aggregated user data and identify one or more user preferences for events and/or types of events. In this exemplary embodiment, preferences engine 114 uses textual, semantic, and related analytical techniques to identify instances of the user explicitly and/or implicitly expressing an affinity for events and/or types of events. For example, preferences engine 114 can identify a user's preference for a particular performer based on explicit expressions such as selecting a “like” button on a web page, writing endorsing statements in an electronic message to other individuals, associating with a fan group on a social media web page, and past attendance of events that included the performer. Similarly, based on such explicit expressions of affinity for a performer, preferences engine 114 can identify an implicit preference for a particular type of event that is associated with the performer, such as theatre or concerts, as well as a preference for similar performers or a genre of music.

In step 306, aggregation program 110 stores the identified user preferences with the user profile in user profile data store 116 (i.e., the user profile created in step 208 of FIG. 2). In this exemplary embodiment, the identified user preferences are stored as keyword tags and phrase tags. For example, an identified user preference for classical music can be stored as a “classical music” tag and/or as a series of related keyword tags, such as “classical music,” “orchestra,” and “concert”. In general, any method of storing identified preferences can be utilized, and user profile data store 116 can be implemented with any database architecture known in the art.

In step 308, aggregation program 110 aggregates event data from the preferred service providers and/or other sources. In this exemplary embodiment, the event data includes information pertaining to one or more scheduled events, including dates, times and locations, which is aggregated from service providers 122 through 128. For example, aggregation program 110 can aggregate event data from databases of upcoming events that are maintained by ecommerce service providers 126 (e.g., a ticketing website) and travel service providers 122, from calendars of events that are maintained by social media service providers 124, and/or from other sources on the Internet.

In step 310, aggregation program 110 utilizes events engine 118 to analyze the aggregated event data and identify one or more upcoming events (e.g., events associated with a date and time that is later than a current system time on server computer system 106). In this exemplary embodiment, events engine 118 uses textual, semantic, and related analytical techniques, as previously discussed with respect to preferences engine 114.

In step 312, aggregation program 110 stores information pertaining to each of the identified upcoming events in events data store 120. In this exemplary embodiment, each identified upcoming event is stored with information pertaining to an associated date, time, and location of the event, descriptive information, and one or more keyword tags pertaining to the name of the event, type of the event, and/or other aspects of the event, as previously discussed. In general, any method of storing the identified upcoming events can be utilized, and events data store 120 can be implemented with any database architecture known in the art.

Accordingly, aggregation program 110 aggregates user and event data, analyzes the aggregated data, and identifies user preferences and upcoming events. As discussed with respect to FIG. 2, aggregation program 110 is run after setting up a user profile (i.e., in step 210). In addition, aggregation program 110 can be run periodically thereafter to maintain and update user preferences and upcoming events.

FIG. 4 is a flowchart illustrating operational steps of recommendation program 112 for recommending events to a user in accordance with an embodiment of the present invention. In this exemplary embodiment, the operational steps of FIG. 4 are performed subsequent to setting up a user profile and aggregating user and event data in accordance with FIGS. 2 and 3, respectively.

In step 402, recommendation program 112 receives a notification indicating that a user has made travel plans. In this exemplary embodiment, the notification is sent by one or more travel service providers 122 indicating that a travel itinerary has been created for a user, and including identifying information for the user.

In step 404, recommendation program 112 validates the user by verifying that a user profile exists in user profile data store 116 for the user whose identifying information has been sent with the notification in step 402. The method of validation can vary depending on the type of authorization utilized during profile setup (i.e., step 206 of FIG. 2). In this exemplary embodiment, the user provided authorization for server computer system 106 and service providers 122 through 128 to utilize federated identity management technology, as previously discussed, and recommendation program 112 validates the user by receiving and verifying the user's federated user identity.

In step 406, recommendation program 112 requests the user's travel itinerary from one or more travel service providers 122 and, in step 408, recommendation program 112 receives the user's travel itinerary from one or more travel service providers 122. In this exemplary embodiment, the travel itinerary includes one or more scheduled times and locations. The scheduled times and locations can correspond to events, arrival and departure points, or any other elements on the user's travel itinerary. In certain embodiments, an operator of server computer system 106 may be required to pay a fee for having access to the user's travel itinerary (e.g., due to a business relationship with the operator of one or more travel service providers 122 or other participating service providers).

In step 410, recommendation program 112 analyzes the user's travel itinerary and identifies one or more events that comport with one or more of the user's preferences for events and coincide with the user's itinerary. In this exemplary embodiment, recommendation program 112 searches events data store 120 for events that are associated with one or more keyword tags that match keyword tags for the user's preferences stored in user profile data store 116 (i.e., events that are of potential interest to the user). Recommendation program 112 then filters the search results based on events that are scheduled to take place at a time and location that is within a specified temporal and spatial proximity of a scheduled time and location in the user's itinerary. The specified temporal and spatial proximity can be configured by the user as part of profile setup or by an administrative user of server computer system 106. For example, if a user's itinerary includes an arrival in New York City on Jan. 1, 2013 at 13:00, and the specified temporal and spatial proximity is 24 hours and 50 miles, respectively, then recommendation program 112 filters the search results for events that are scheduled at a time and place that is within 24 hours after 13:00 on Jan. 1, 2013 and 50 miles of New York City.

In step 412, recommendation program 112 notifies the user of the one or more events identified in step 410. In this exemplary embodiment, recommendation program 112 notifies the user by transmitting an electronic message to the user. The notification includes descriptive information pertaining to the identified one or more events, as well as selectable elements (e.g., buttons or hyperlinks) to purchase tickets and other goods that pertain to the events, which can be configured to direct web browser 104 to service providers such as one or more ecommerce service providers 126. For example, recommendation program 112 can notify the user via e-mail, via a cellular text message, via a push notification on the user's mobile computer device, and/or via a popup window in web browser 104. The notification can also include different types and amounts of content that pertains to the identified one or more events.

FIG. 5 is a block diagram of internal and external components of a computer system 500, such as client computer system 102 and server computer system 106, in accordance with an embodiment of the present invention. It should be appreciated that FIG. 5 provides only an illustration of one implementation and does not imply any limitations with regard to the environments in which different embodiments may be implemented. In general, the components illustrated in FIG. 5 are representative of any electronic device capable of executing machine-readable program instructions. Examples of computer systems, environments, and/or configurations that may be represented by the components illustrated in FIG. 5 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Client computer system 102 and server computer system 106 each include one or more buses 502, which provide for communications between one or more processors 504, memory 506, persistent storage 508, communications unit 512, and one or more input/output (I/O) interfaces 514.

Memory 506 and persistent storage 508 are examples of computer-readable storage media. Computer-readable storage media are capable of storing information such as data, program code in functional form, and/or other suitable information on a temporary basis and/or permanent basis. One or more operating systems and web browser 104 on client computer system 102, and one or more operating systems, profile setup program 108, aggregation program 110, recommendation program 112, preferences engine 114, user profile data store 116, events engine 118, and events data store 120, are stored in their respective persistent storage 508 for execution and/or access by one or more of the respective processors 504 via one or more memories of memory 506.

Memory 506 can include one or more random access memories (RAM) 516, cache memory 518, or any other suitable volatile or non-volatile storage medium. In the embodiment illustrated in FIG. 5, persistent storage 508 is a magnetic disk storage medium of a hard drive. Alternatively, persistent storage 508 can be a semiconductor storage medium such as ROM, EPROM, flash memory or any other computer-readable storage medium that can store a computer program and digital information. The media used by persistent storage 508 can also be removable. For example, a removable hard drive can be used for persistent storage 508. Other examples include optical or magnetic disks, thumb drives, or smart cards that are inserted into a drive for transfer onto another storage medium that is also a part of persistent storage 508.

Communications unit 512 provides for communications with other computer systems or devices via a network, such as network 130. In this exemplary embodiment, communications unit 512 includes network adapters or interfaces such as a TCP/IP adapter cards, wireless Wi-Fi interface cards, or 3G or 4G wireless interface cards or other wired or wireless communication links. The network can comprise copper wires, optical fibers, wireless transmission, routers, firewalls, switches, gateway computers and/or edge servers. Software and data used to practice embodiments of the present invention can be downloaded to client computer system 102 and/or server computer system 106 through communications unit 512 (e.g., via the Internet, a local area network or other wide area network). From communications unit 512, the software and data can be loaded onto persistent storage 508.

One or more I/O interfaces 514 allow for input and output of data with other devices that may be connected to client computer system 102 and/or server computer system 106. For example, I/O interface 514 can provide a connection to one or more external devices 520 such as a keyboard, computer mouse, touch screen, virtual keyboard, touch pad, pointing device, or other human interface devices. I/O interface 514 also connects to display 522.

Display 522 provides a mechanism to display data to a user and can be, for example, a computer monitor. Alternatively, display 522 can be an incorporated display and may also function as a touch screen, such as a built-in display of a tablet computer.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing description of various embodiments of the present invention has been presented for purposes of illustration and description. It is not intended to be exhaustive nor limit the invention to the precise form disclosed. Many modifications and variations of the present invention are possible. Such modifications and variations that may be apparent to a person skilled in the art of the invention are intended to be included within the scope of the invention as defined by the accompanying claims.

What is claimed is:

1. A method for providing event recommendations to a user, the method comprising the steps of:
a computer system identifying a travel itinerary that has been created for a user, wherein the travel itinerary includes at least one scheduled time and location;
the computer system aggregating data that pertains to the user from one or more service providers;
the computer system analyzing the aggregated data to identify a user preference;
the computer system identifying an event of potential interest to the user that coincides with the travel itinerary; and
the computer system notifying the user of the identified event.

2. The method of claim 1, wherein the step of the computer system identifying a travel itinerary that has been created for a user comprises the steps of:
the computer system receiving a notification from a second computer system indicating that the travel itinerary has been created for the user;
the computer system authenticating the user; and
the computer system receiving the travel itinerary from the second computer system.

3. The method of claim 1, wherein the step of the computer system identifying an event of potential interest to the user that coincides with the travel itinerary comprises the step of:
the computer system identifying an event that comports with the user preference and is scheduled to take place at a time and location that is within a specified temporal and spatial proximity of the at least one scheduled time and location.

4. The method of claim 1, wherein the step of the computer system identifying an event of potential interest to the user that coincides with the travel itinerary comprises the step of:
the computer system identifying an event that is scheduled to take place at a time and location that is within a specified temporal and spatial proximity of the at least one scheduled time and location and is associated with a keyword tag that matches a keyword tag that is associated with the user preference.

5. The method of claim 1, wherein the step of the computer system notifying the user of the identified event comprises the steps of:
the computer system transmitting an electronic message to the user; and
the computer system providing the user with one or more options to purchase goods that pertain to the identified event.

6. The method of claim 1, wherein the one or more service providers comprise a social media service provider and messaging service provider.

7. The method of claim 1, wherein the step of the computer system analyzing the aggregated data to identify a user preference comprises the step of:
the computer system determining that the user has expressed an affinity for a type of event.

8. A computer system for providing event recommendations to a user, the computer system comprising:
one or more processors, one or more computer-readable memories, one or more computer-readable storage media, and program instructions stored on at least one of the one or more computer-readable storage media for execution by at least one of the one or more processors via at least one of the one or more computer-readable memories, the program instructions comprising:
program instructions to identify a travel itinerary that has been created for a user, wherein the travel itinerary includes at least one scheduled time and location;
program instructions to aggregate data that pertains to the user from one or more service providers;
program instructions to analyze the aggregated data to identify a user preference;
program instructions to identify an event of potential interest to the user that coincides with the travel itinerary; and
program instructions to notify the user of the identified event.

9. The computer system of claim 8, wherein the program instructions to identify a travel itinerary that has been created for a user comprise program instructions to:
receive a notification from a second computer system indicating that the travel itinerary has been created for the user;
authenticate the user; and
receive the travel itinerary from the second computer system.

10. The computer system of claim 8, wherein the program instructions to identify an event of potential interest to the user that coincides with the travel itinerary comprise program instructions to:
identify an event that comports with the user preference and is scheduled to take place at a time and location that is within a specified temporal and spatial proximity of the at least one scheduled time and location.

11. The computer system of claim 8, wherein the program instructions to identify an event of potential interest to the user that coincides with the travel itinerary comprise program instructions to:
identify an event that is scheduled to take place at a time and location that is within a specified temporal and spatial proximity of the at least one scheduled time and location and is associated with a keyword tag that matches a keyword tag that is associated with the user preference.

12. The computer system of claim 8, wherein the program instructions to notify the user of the identified event comprise program instructions to:
transmit an electronic message to the user; and
provide the user with one or more options to purchase goods that pertain to the identified event.

13. The computer system of claim 8, wherein the one or more service providers comprise a social media service provider and a messaging service provider.

14. The computer system of claim 8, wherein the program instructions to analyze the aggregated data to identify a user preference comprise program instructions to:
determine that the user has expressed an affinity for a type of event.

15. A computer program product for providing event recommendations to a user, the computer program product comprising:
one or more computer-readable storage media and program instructions stored on at least one of the one or more computer-readable storage media, the program instructions comprising:
program instructions to identify a travel itinerary that has been created for a user, wherein the travel itinerary includes at least one scheduled time and location;
program instructions to aggregate data that pertains to the user from one or more service providers;
program instructions to analyze the aggregated data to identify a user preference;
program instructions to identify an event of potential interest to the user that coincides with the travel itinerary; and
program instructions to notify the user of the identified event.

16. The computer program product of claim 15, wherein the program instructions to identify a travel itinerary that has been created for a user comprise program instructions to:
receive a notification from a second computer system indicating that the travel itinerary has been created for the user;
authenticate the user; and
receive the travel itinerary from the second computer system.

17. The computer program product of claim 15, wherein the program instructions to identify an event of potential interest to the user that coincides with the travel itinerary comprise program instructions to:
identify an event that comports with the user preference and is scheduled to take place at a time and location that is within a specified temporal and spatial proximity of the at least one scheduled time and location.

18. The computer program product of claim 15, wherein the program instructions to identify an event of potential interest to the user that coincides with the travel itinerary comprise program instructions to:
identify an event that is scheduled to take place at a time and location that is within a specified temporal and spatial proximity of the at least one scheduled time and location and is associated with a keyword tag that matches a keyword tag that is associated with the user preference.

19. The computer program product of claim 15, wherein the program instructions to notify the user of the identified event comprise program instructions to:
transmit an electronic message to the user; and
provide the user with one or more options to purchase goods that pertain to the identified event.

20. The computer program product of claim 15, wherein the one or more service providers comprise a social media service provider and a messaging service provider.

21. The computer system of claim 15, wherein the program instructions to analyze the aggregated data to identify a user preference comprise program instructions to:
determine that the user has expressed an affinity for a type of event.
